(19) United States
(12) Patent Application Publication
(10) Pub. No.: US 2011/0213486 A1
(43) Pub. Date: Sep. 1, 2011

(54) METHOD AND DEVICE FOR CONTROLLING THE SOLIDIFICATION OF A CAST STRAND IN A STRAND CASTING PLANT IN STARTUP OF THE INJECTION PROCESS

(75) Inventor: Uwe Plociennik, Ratingen (DE)

(73) Assignee: SMS SIEMAG AKTIENGESELLSCHAFT, Düsseldorf (DE)

(21) Appl. No.: 13/127,573

(22) PCT Filed: Nov. 4, 2009
(86) PCT No.: PCT/EP2009/007903

§ 371 Date: May 4, 2011

(30) Foreign Application Priority Data
Nov. 4, 2008 (DE) 10 2008 055 783.8

(51) Int. Cl. G06F 19/00

(52) U.S. Cl. 700/103

(57) ABSTRACT

A method for casting a cast strand (4) in a continuous casting installation equipped with a process computer and having at least one casting machine, the process computer comprising a first software (2), which computes in real time and regulates the casting process, is characterized in that a second additional fast-computing software (1) in the process computer controls the casting process during the initial phase of a newly starting casting process or when there is a change in parameters of the cast strand to be cast during the ongoing process, in that the second software (1) processes currently gained data from the ongoing casting process and/or processes stored data from a database (8) and generates correction factors, with the help of which the second software (1) generates corrected target data for the casting process, until the time when the casting process is represented completely using the data calculated in real time, and the first software (2) regulates the casting process using only these data.

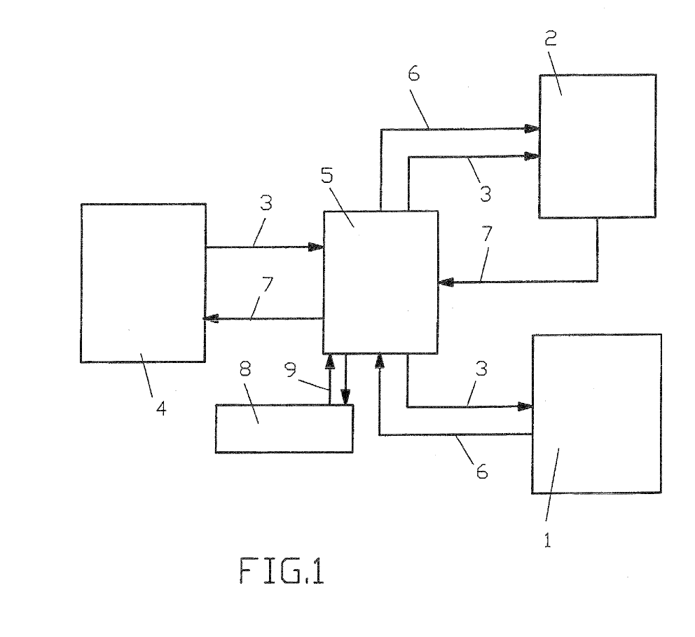

The invention relates to a method for casting a cast strand in a continuous casting plant having a process computer with at least one casting machine, wherein the process computer comprises a first software which computes in real time and regulates the casting process.

From W0 2000 05014 A1 is known a continuous casting plant with a computer by means of which various production orders are to be carried out. For this purpose, the sequence of the slabs assigned to the production orders is determined within the sequences with the computer by means of a genetic algorithm and the casting plant is controlled accordingly with a to be determined sequence of the computer. The genetic algorithm is to be capable of taking into consideration the technical and order-related restrictions in an optimum manner in order to facilitate an optimum manner of operation of the continuous casting plant.

W0 2004 048016 A2 discloses a method and a device for continuously casting slabs, thin slabs, blooms, pre-sections, billet strands and the like from liquid metal, particularly from steel material. A plant control by means of a computer is present to which the respectively local measurement values of the cooling medium, the cooling medium quantity, the cooling medium pressure of the secondary cooling zone and the measurement values of the adjusting forces back-up roller stand and the surface temperature at the sump tip of the metallurgical strand length online on the inlet side.

W0 1996 28772 A1 concerns a guiding system for a plant of the basic material or processing industries, particularly for a metallurgical plant. In such a guide system, the particular object is to achieve during strip casting of metal strip a better production success. For this purpose, a guide system is utilized which, based on entered prior knowledge, provides automatically instructions which are appropriate for this situation in order to achieve a secure and optimum process guidance.

In accordance with a development of the guiding system, it is provided that the guiding system has a basic function system for the plant components which securely converts into the plant guidance the instructions obtained by computer technology, for example, from a process model, preferably a total process model.

U.S. Pat. No. 6,564,119 B1 discloses a method of monitoring the operation of a continuous casting process in which a multivariable statistical model is utilized which also utilizes process parameters measured outside of the production process which are to represent the normal manner of operation of the casting plant. The purpose is to be able to predict breakthroughs in a casting mold. The occurrence of an undesirable solidification of the steel in the casting mold on the basis of a multivariable statistical model of the normal function is predicted.

W0 2005 120747 A1 discloses a method for continuously casting a metal strand with a continuous mold, and a strand support device arranged following the mold. For obtaining a certain structure in the cast strand, the continuous casting operation is carried out on the basis of a thermo mechanical computer model that describes the load of the metal during casting and during the thereby occurring solidification process, by means of which the current load acting on the strand is computed online. The variable influencing the material burden, such as the specific cooling quantity intended for cooling the strand, is adjusted during the ongoing casting process. For forming a desired crack-free structure, a computer model is utilized which describes the crack sensitivity of the structure and the crack forming energy stored in the structure.

In WO 2004 080628 A1, a casting roll plant producing a steel strip is described, in which all components of the plant are guided through technological regulation cycles. For integrating the adjustment of the technological regulating circuit, the plant comprises a guiding system operating on the basis of mathematical models which connects the liquid steel device, the liquid steel addition device, the casting device, the reduction device, the deflection unit, the rolling mill, and the reeling device of the casting roll plant with each other. Individual plant parts are guided in relation to their interaction so that the effects of the regulation steps of a plant portion take into consideration the plant portions following in material flux direction.

When continuously casting steel, the solidification is achieved by the primary cooling of the steel in the mold and the secondary cooling in the area of the strand guidance. Within the strand guidance, water or water/air mixture is sprayed under pressure into the area remaining between the strand guide rollers directly onto the strand shell; as a result, heat is removed from the strand. The pattern of solidification can be divided into several phases. In the mold, initially a thin strand shell solidifies with a thickness of several millimeters which is distinguished by a finely granular structure. Because of the high solidification speed, differences in the chemical composition can practically not be compensated by diffusion. For this reason, the composition of the alloy elements in the strand shell differs from the proportion of the respective elements in the melt. For example, individual elements are enriched in the melt.

With increasing thickness of the strand shell, the heat transport from the liquid steel in the strand core through the strand shell to the outside becomes poorer. A phase of directed dendritic solidification to the outside begins, wherein the principal axes of the dendrites are aligned along the thermal flux direction. Also in this case, the solidification speed is still so high that some alloy elements in the residual melt continue to enrich. A portion of the enriched melt remains back between the dendrite arms, so that the chemical composition of the solidified strand shell may change within brief intervals. In dependence on the flowability of the solidifying residual melt, the geometric ratios between the growing strand shells starting at a certain point in time, i.e., when reaching the so called critical sump diameter, prevent the further exchange of the melt. Using the process of soft reduction as is already known from EP 0 450 391 B1, a method for reducing undesired liquation effects is available. In this connection, the strand thickness in the area of the final solidification is reduced by external forces additionally to thermal shrinkage in order to compensate the increased volume reduction of the liquid strand core and to prevent intake of enriched residual melt.

From the essay [Soft Reduction von Knüppeln auf der Stranggieβanlage S0 der Saarstahl AG] “Soft reduction of billets on the strand casting plant S0 of Saarstahl AG” [Stahl und Eisen 127 (2007) no. 2, pages 43-50], a method is known by which it is possible in an uncomplicated manner to evaluate the effect of the soft reduction or the effect of the soft reduction on the internal quality of the cast strand. For this purpose, in the area of the secondary cooling all the rollers are lifted which participate in the soft reduction or are located behind the area of the soft reduction. From this essay it is also known how to regulate by means of mathematical/physical models the temperature, the sump tip or the position of the critical sump diameter. Adjusting values for the regulating processes are the water quantity of the secondary cooling and the casting speed.

It is the object of the invention to improve the productivity in the manufacture of a cast strand by adhering to the desired material conditions after only a few meters of a slab, an ingot or billet of a metal strand have been cast.

In accordance with the invention, this object is met in a method of the above-described type in that a second additional high-speed software in the process computer of the casting process influences during the initial phase of a newly started casting process or in the case of a parameter change of the strand to be cast during the ongoing process, in that the second software processes actually obtained data from the ongoing casting process and/or stored data from a data bank and produces correction factors, with the help of the second software corrected desired data for the casting process is produced until the point in time at which the casting process is completely represented with the data computed in real time, and the first software regulates the casting process exclusively with these data.

In this manner, it is possible to reduce the length of the strand material which is conventionally described as not being usable, particularly in the start-up phase of the casting process. Conventionally, a strand length of up to 25 m of a bloom or slab is not usable. If it is taken into consideration that frequently up to six strands of blooms or two strands of slabs are cast and straightened in parallel, this results, according to the prior art, in a loss of an entire bloom length of 150 m, which is avoided by the invention.

Since, however, in the start-up phase at least the length of the area of the secondary cooling of the cast strand is required until the first software of the plant computer, which is provided for determining in real time the desired values, for example the quantity of the cooling water, can evaluate the regulation variable, and since additional time passes until the regulation variable can be maintained, according to the invention, a second software is used in the same plant computer in order to be able to in this manner supply the required regulation parameters from the outside, so that, contrary to the state of the art, almost no strand material which is not usable is produced, starting virtually at the beginning of the casting process, i.e., from the time when the cast strand produced underneath the casting mold. The invention increases the productivity, because already in the first few cast meters the variables or variable ranges of the cast strand predetermined for the ongoing operation can be maintained. This is achieved by installing parallel to the first software computing in real time another software, the high-speed second software, that is used for producing the desired data from beginning of the process or when changing the process parameters, such as thickness or width of the cast strand.

The object of the second software is to be able to determine with the process parameters and the desired values (intended temperature, intended position of the critical sump diameter, or of the intended sump tip) already at the start of casting or when switching on the regulation, the necessary cooling agent quantities (water quantity). This is particularly important because the intended values are substantially influenced by the actual process parameters, such as the actual state analysis, the overheating of the melt, the actual cooling temperatures of the cooling agent (water) of the second cooling and the heat removal in the mold.

Advantageous further developments of the invention result from the dependent claims, the specifications and the single FIGURE.

Preferably, the second software uses process parameters as well as intended values of the casting process.

Advantageously, as intended values are understood to be the intended casting speed, particularly in the case of larger strand cross sections of the casting strands, the intended temperature of the cast strands at a predetermined position or the intended temperatures at several predetermined positions, particularly at the surface, the intended position of the critical sump diameter (CMD) (CMD=critical mushy diameter) and/or the intended sump tip of the cast strand in the area of the outlet of the casting machine. Larger strand cross sections are understood to be those having more then 200 mm.

Advantageously, used as process parameters are the result of a steel analysis, temperatures of the metal melt in the tundish, in the casting mold, cooling water quantities for cooling the mold, and the secondary cooling area as well as the cooling water temperatures of the cooling water for cooling the mold and in the secondary cooling area.

It can advantageously also be provided that, when either the first software and/or the second software are switched off, a third software for the data transfer between the strand casting plant and the first and the second software has the effect that after switching on the first and the second software for a predetermined period of time, the intended data for the strand casting process are produced exclusively with the use of data stored in the data bank.

It is also advantageous if the second software includes a data bank with stored process data which by means of a simulation or a replay function subsequently simulate the sequence of a casting process which has been carried out.

It is also advantageous if the second software utilizes a modified simulation or replay function, in order to reduce the downtime up to the start of the first software.

Additionally, it is advantageously provided that a device for measuring the strand length of cast strand is measured and that, when a predetermined strand length is exceeded, the replay function can be switched on.

As a rule, the invention will be realized as a software solution for improving the functions of a computer of a continuous casting plant which is already known with at least one continuous casting mold. However, the invention can also be realized alternatively in the form of an additional computer or a computer equipped with additional work storage means.

In this case, the invention also relates to a device for controlling the casting process in a continuous casting plant with a regulation device operating in real time for carrying out a method as it is described above.

The device is characterized in accordance with the invention in that it includes a high-speed computer for making available intended data and process data in the initial phase of the casting process or during the change of the metals to be cast or of the metal alloy during the ongoing casting process, and that the regulating unit instead of the data computed in real time uses the data made available by the high speed computer.

Preferably, the device includes a data bank with stored process data, wherein the high-speed computer simulates by means of a simulation function (replay function) the sequence of a casting process which has been carried out. In addition, it is provided that the process data stored in the data bank are useable during the initial phase of the casting process or in the case of a change within the current casting process through the regulating unit.

Another advantage is obtained if the high-speed computer uses a modified simulation function in order to reduce the dead time up to the use of the regular regulating device.

Subsequently, the invention will be explained in more detail with the aid of an embodiment illustrated in a single FIGURE. The drawing shows schematically the data transfer within the strand casting plant.

In order to be able to carry out the computation as quickly as possible, at the beginning of a casting process, a software 1 (FIGURE) for producing intended data for the process for casting the cast strand and simultaneously the software 2 computing in real time, are supplied all process data 3 from a cast strand 4 through a point 5 of data intersection. However, the software 1 does not contain the actual casting speed, but instead the, for example, stored in a cooling program that determines the data for cooling the strand, intended casting speed and the intended values. Using this information, the software 1 simulates the strand casting process much more quickly than in real time and regulates within the simulation the intended values through changes of the regulating values, such as water quantity and casting speed. In this manner, it becomes possible to make available the cooling agent quantities necessary in the casting process for achieving the intended values as quickly as possible. The software 1 determines an actual correcting factor 6 for the special cooling agent application during the initial phase of the casting process; the correction factor 6 is conducted through the intersection point 5 at the circuit part for computing with the software 2. This then produces intended data 7 for the cooling agent quantity, particularly the water quantity, and sends this data through the intersecting point 5 to the cast strands 4. Complete data are transferred to a data bank (8).

From the data bank 8, the software 1 takes the data 9 from prior casting processes which can be used for the regulation of the initial phase of the casting process which has just been concluded, and which are transferred through the data intersection 5 to the software 1. In particular, this is possible and required if, for example, because of an operator error the computing plant was not switched on with the exception of the data intersection 5 and the software belonging to the data intersection 5 was not switched on for a period of time. If then the computing plant is switched on, the software 2 assumes the required data from the data bank 8 which are made available through the data intersecting point 5.

In the case of larger strand cross sections, a regulation to an intended position of the critical sump diameter in the cast strand is not suitable by means of the cooling agent because in that case there is the danger that the surface temperatures are too low which would lead to surface damage of the strand. In that case, a control of the casting speed for the regulation of the critical sump diameter (CMD=critical mushy diameter) is better suited.

Modified replay functions make it possible for the operator of the continuous casting plant to once again simulate castings which were carried out in the past. This takes place by processed data stored in the data bank 8.

Another possibility for reducing the waste or the quality devaluation of continuously cast material resides in utilizing a modified replay function when the software 1 and/or the software 2 of the computer were switched on too late. The modified replay function makes it possible to reduce the dead time up to the start-up of the computing process with the software 1, 2 by carrying out the simulation not in real time but with maximum computing speed.

This can be achieved by examining the actual casting when the software 1, 2 is switched on. If the casting length is greater than, for example, ten meters, automatically the replay function is switched on. The actual process data are now no longer supplied to the software, but by means of the replay function the process data stored in the data bank 8 are transmitted. The software 1, 2 then computes as fast as possible and only when the simulated casting length coincides with the actual casting length, the software 1, 2 again switches into the normal regulating mode, in which the actual process data are processed in real time.

### REFERENCE NUMBERS

1 Software
2 Software
3 Process data
4 Cast strand
5 Data intersection
6 Correction factor
7 Intended data
8 Data bank
9 Data stored from previous casting processes

1-11. (canceled)

12. A method for casting a cast strand in a continuous casting plant equipped with a process computer, with at least one casting machine, wherein the process computer comprises a first software which computes in real time, the method comprising the steps of: regulating the casting process with the first software; and influencing the casting process with a second additional, rapidly computing software in the process computer during an initial phase of a newly started casting process or when there is a parameter change of the cast strand during an ongoing process, by processing actually obtained data from the ongoing casting process and/or stored data from a data bank and obtaining correction factors from which the second software produces corrected intended data for the casting process until a point in time at which the casting process is completely represented by data computed in real time and the first software exclusively regulates the casting process by these data.

13. The method according to claim 12, wherein the second software utilizes process parameters as well as intended values of the casting process.

14. The method according to claim 13, including utilizing as intended values intended casting speed, desired temperature of the cast strand at a predetermined position or intended temperature at several predetermined positions, desired position of the critical sump diameter (CMD) (CMD=critical mushy diameter) and/or intended position of the sump tip of the cast strand in an area of an outlet of the casting machine or below the outlet.

15. The method according to claim 14, including utilizing as intended values the intended casting speed at greater strand cross-sections of the cast strand.

16. The method according to claim 15, including utilizing as intended values the intended casting speed in strand cross-sections of more than 200 mm.

17. The method according to claim 14, including utilizing intended temperatures at the surface of the strand.

18. The method according to claim 12, including utilizing as process parameters a result of a steel analysis, temperatures of the metal melt in a tundish, in a casting mold, cooling water quantities for cooling the mold and a secondary cooling area as well as cooling water temperatures of the cooling water for cooling the mold and in the secondary cooling area.

19. The method according to claim 12, wherein when either the first software and/or the second software are switched off, a third software for the data transfer between the strand casting plant and the first and the second softwares produces an effect that after switching on the first and second softwares for a predetermined period of time the intended data for the strand casting process are exclusively processed with the use of data stored in the data bank.

20. A Device for controlling a casting process in a continuous casting plant with a regulating device computing in real time for carrying out a method according to claim 12, the device comprising: a high-speed computer for making available intended data and process data in an initial phase of the casting process or during an exchange of the metal to be cast or the metal alloy during an ongoing casting process; and a regulating device that utilizes data made available by the high-speed computer instead of data computed in real time.

21. The device according to claim 20, further comprising a data bank with stored process data, wherein the high-speed computer simulates, by a simulating function (replay function), a sequence of a casting process which has been carried out subsequently, and wherein the process data stored in the data bank during the initial phase of the casting process or in the event of a change within the ongoing casting process is utilized by the regulating device.

22. The device according to claim 20, wherein the high-speed computer utilizes a modified simulation function in order to reduce dead time up to a time of use of the regulating device.
